(19) United States
(12) Patent Application Publication
(10) Pub. No.: US 2013/0134139 A1
(43) Pub. Date: May 30, 2013

(54) PULSED LASER MACHINING METHOD AND PULSED LASER MACHINING EQUIPMENT, IN PARTICULAR FOR WELDING WITH VARIATION OF THE POWER OF EACH LASER PULSE

(71) Applicants: Ulrich Duerr, Allmendingen (CH); Christoph Ruettimann, Thun (CH); Bruno Frei, Thierachern (CH)

(72) Inventors: Ulrich Duerr, Allmendingen (CH); Christoph Ruettimann, Thun (CH); Bruno Frei, Thierachern (CH)

(73) Assignee: ROFIN-LASAG AG, Thun (CH)

(21) Appl. No.: 13/701,735

(22) PCT Filed: May 9, 2011
(86) PCT No.: PCT/EP11/57441

§ 371 Date: Feb. 14, 2013

(30) Foreign Application Priority Data
Jun. 3, 2010 (EP) 10164824.4

(51) Int. Cl. B23K 26/20

(52) U.S. Cl. CPC B23K 26/20
USPC 219/121.63

(57) ABSTRACT

A laser machining method includes A) generating, by a laser source, a laser beam having an initial wavelength between 700 and 1200 nanometers of laser pulses; B) doubling frequency of one part of the laser beam by a non-linear crystal; C) varying power throughout each emitted laser pulse so that the power profile has a maximum peak power or part of the pulse with a maximum power in an initial sub-period, and throughout an intermediate sub-period of longer duration than the initial sub-period, a lower power than the maximum power. The maximum power value is at least two times higher than the mean power throughout the laser pulse and an increase time to maximum power from a start of each laser pulse is less than 0.3 milliseconds. The machining method can concern welding highly reflective metals, copper, gold, silver, or an alloy including one of these metals.

### FIELD OF THE INVENTION

The present invention concerns the field of laser welding and in particular the laser welding of highly reflective materials, such as copper, gold, silver, aluminium or an alloy comprising one of these metals. More specifically, the invention concerns a laser welding method and an equipment for implementing said method where the coherent light source generates a laser beam with a wavelength of between 700 and 1200 nanometres, for example an Nd:YAG laser or fibre laser. A non-linear crystal is provided for partially doubling the frequency of the laser beam so as to increase machining efficiency.

### BACKGROUND OF THE INVENTION

A laser welding equipment is known from U.S. Pat. No. 5,083,007 comprising an Nd:YAG laser source optically pumped using a flash lamp and generating a coherent light with a wavelength of 1064 nanometres (nm), and a non-linear crystal (for example LiNbO₃ or KTP) arranged in the resonant cavity, said crystal partially doubling the frequency of the light generated by the laser source. At the output of the resonant cavity, there is thus a laser beam formed of two wavelengths, i.e. 1064 nm (infra-red light) and 532 nm (green light). This document proposes to produce a pulsed laser beam with at least 3% light having a wavelength of between 350 and 600 nm generated by a 2 F frequency converter. Preferably, the laser pulses have at least 30 MJ energy with at least 3 MJ from the frequency doubled light. The duration of the pulses is arranged to be between 0.5 milliseconds (ms) and 5.0 ms.

U.S. Pat. No. 5,083,007 essentially discloses three embodiments for the laser welding equipment. In the first embodiment (FIG. 1), there is generated a laser beam of relatively low instantaneous power to avoid damaging the non-linear crystal, so as to obtain a percentage of between 5% and 15% green light with the crystal arranged intracavity. To increase this percentage of green light, an infra-red reflector which filters part of the infra-red light is optionally provided. In a second embodiment, a mirror which reflects little green light is selected at the resonant cavity output, which increases the quantity of green light in the laser pulses. It will be noted here that the ratio between infra-red light and green light is fixed. In the third embodiment, to be able to adjust the ratio between these two types of radiation in the laser beam, these two types of radiation may be separated and then independently attenuated by filters. This allows the ratio between the two types of radiation to be varied while reducing the incident laser power on the material for a given transmitted power. The efficiency of the laser system is therefore reduced. Further, it will be noted that this method allows the ratio between green light and infra-red light to be varied between two distinct welding operations since it is necessary to change at least one attenuator filter to modify said ratio.

In all the embodiments given in U.S. Pat. No. 5,083,007, the laser pulses are arranged to be formed by switching the flash lamp ON/OFF. As shown in FIG. 2 of that document, this results in pulses wherein, as soon as the pumping means is switched ON, the power profile exhibits an exponential increase up to a maximum level which is maintained while the pumping means remains active, i.e. throughout the body of the pulse, the duration of which is related to the period of the pulse, then the power drops exponentially as soon as the optical pumping means is switched OFF. There is therefore no management or control of the power profile during each pulse. The power remains at a maximum except at the two ends where the profile depends only on the physical characteristics of the laser source and optical pumping means. Consequently, the ratio between the green light and infra-red light remains substantially constant over most of each pulse. This causes a problem in particular for highly reflective metals. Indeed, the conversion rate of 2 F crystal increases with the intensity of the incident laser beam.

The laser beam proposed in U.S. Pat. No. 5,083,007 supplies pulses by modulating the optical pumping power between a low level (OFF) and a high level (ON). To increase the green light power in pulses generated by this type of laser, the power of the pumping means must be increased. Increasing the proportion and quantity of green light in the pulses also increases the quantity of infra-red light and in any event the overall quantity of energy per pulse. It was observed that this causes a problem for the quality of the weld formed since, if the initial coupling of green light in the material is better, once the local temperature of the welded material increases significantly, the infra-red energy is also well absorbed. This then leads to the absorption of excessive energy intensity and the appearance of damaging secondary thermal effects, such as plasma formation and the ejection of melted material outside the surface of the material. However, if the power of the pulsed laser is reduced to limit the quantity of infra-red light absorbed per pulse, the proportion and quantity of green light energy supplied decreases and the weld efficiency is reduced. Further, the reproducibility of a given weld becomes very dependent on the surface state of the welded material. It becomes complex and difficult to control the quality of the weld formed.

### SUMMARY OF THE INVENTION

FIG. 1 shows approximately the absorption coefficient of four highly reflective metals (copper, gold, silver and aluminium) at substantially ambient temperature according to the wavelength of the incident laser light on each metal. A very low light absorption rate is observed for the 1064 nm wavelength which is the radiation generated by an Nd:YAG laser, in particular for copper (Cu), gold (Au) and silver (Ag). Conversely, at double the frequency (i.e. at 532 nm), it is observed that the absorption rate greatly increases to reach around 20% (at ambient temperature) for copper and gold. This rate can rise to around 40% as soon as the temperature increases. This explains why the mixed beam proposed in the aforementioned prior art increases the efficiency of a weld. It will be noted however that the percentages given here are illustrative since they also depend on other parameters such as the surface state of the metal.

However, for infra-red light, the situation shown in FIG. 1 varies considerably when the surface temperature of the metal increases, and there is a significant jump when this temperature reaches the melting temperature, as is shown approximately in FIG. 2 for copper. For an incident infra-red light from an Nd-YAG (1 μm) laser, a change is observed from an absorption coefficient of less than 5% at ambient temperature to around 10% close to melting temperature T_{M}. At melting temperature, this coefficient becomes higher than 15% and it then continues to increase with an increase in the temperature of the melting metal. This observation provides an explanation of the problem observed in the prior art. By increasing the power of the laser device to have more energy coupled to the metal in the initial welding phase, the prior art increases the infra-red light power throughout the period of the pulse, which is increasingly absorbed as soon as the surface temperature of the material increases; which actually happens quickly. The initial weld efficiency increases, but the overall quantity of energy finally absorbed becomes too great and causes secondary problems detrimental to the quality of the weld, particularly to the surface state after welding.

It is an object of the present invention to overcome the problem highlighted above within the scope of the present invention by fitting the laser equipment with a control means arranged to form laser pulses with a power profile over the period of each laser pulse which, in an initial sub-period, has a maximum power peak or part of a pulse with a maximum power peak and, in an intermediate sub-period of greater duration than the initial sub-period and immediately thereafter, a lower power than said maximum power throughout the entire intermediate sub-period. The value of the maximum power is at least two times higher than the mean power throughout the period of the laser pulse. Further, the duration or time of increase to maximum power from the start of the laser pulse is arranged to be less than 300 μs and preferably less than 100 μs. In particular, the duration of the initial sub-period is less than two milliseconds (2 ms) and preferably less than 1 ms. The laser pulse preferably ends in an end sub-period where the power decreases rapidly, preferably in a controlled manner to optimise the cooling of a weld.

The invention therefore concerns a laser machining method as defined in claim 1 annexed to this description. Particular features of this method are given in the claims dependent on claim 1. The invention also concerns a laser machining equipment as defined in claim 13. Particular features of this equipment and the control means thereof are given in the claims dependent on claim 13.

Owing to the features of the invention, which introduce control of the luminous power emitted during each laser pulse and define a power profile with relatively high power in an initial phase of the pulse and reduced power after this initial phase, a significant quantity of frequency doubled light is obtained in the initial phase and then, when the absorption of light at the initial frequency of the laser source has sufficiently increased following the increase in surface temperature of the machined material, the light power emitted is significantly decreased to limit the quantity of energy absorbed and preferably to temporally control the luminous power absorbed during the intermediate phase of the laser pulse.

It will be noted that the control of the power profile of each laser pulse in the first phase is specifically arranged to optimise the production of frequency doubled light, which is better absorbed than single frequency light in this initial phase where the temperature of the welded material is initially lower than its melting temperature. Thus, the maximum power is arranged to be rapidly increased to rapidly obtain a frequency doubled luminous power which is sufficient to rapidly heat the welded material. According to the invention, the duration or time of increase to maximum power is less than 300 μs (0.3 ms) and preferably less than 100 μs (0.1 ms).

The maximum power of the initial peak must be sufficient to couple the frequency doubled luminous energy to the material in an optimum manner, but not too high since with a good desirable conversion rate, the quantity of frequency doubled light may become large and even preponderant. Conversely, during the next phase, the energy transmitted to the material is essentially controlled by the single frequency light to perform the weld. In this subsequent phase, the power is decreased and the power converted into frequency doubled light has only a secondary or even insignificant role. The power peak in the initial phase generates a sort of initial frequency doubled pulse, which is followed by a single frequency pulse. In each generated laser pulse there is therefore a combination of two successive pulses, wherein the frequency of the first is double that of the second. Each of these two pulses is adapted to the temperature change of the material during welding and to the absorption thereof by the material. The initial peak is therefore used to obtain an initial frequency doubled pulse, the power of which is sufficient to rapidly raise the temperature of the welded material, said initial peak having, according to the invention, a power at least twice as high as the mean power of the pulse since the conversion rate of non-linear crystal is much less than 100% and is also dependent on the luminous intensity received by the crystal.

By limiting the duration of high power simply to the initial phase, the power in the initial phase, where the frequency doubled light is mostly absorbed, is thus controlled differently from in the intermediate phase during which the actual weld takes place and where the light at the initial wavelength is well absorbed. Further, this enables a relatively high power to be supplied in the initial phase to increase the conversion rate by the non-linear crystal. Indeed, this conversion rate increases proportionally to the incident luminous intensity, and consequently the frequency doubled luminous power increases proportionally to the square of the incident power. Thus, in order to obtain a maximum of frequency doubled light in the initial phase, it is advantageous to provide a relatively high luminous power in this initial phase. Since the power emitted in this initial phase does not define the power emitted in the subsequent phase, this does not cause any problems of machining quality. A relatively high power peak can thus be provided in this initial phase which causes a rapid and efficient start of machining at the surface of the machined material. This has another advantage since it is not necessary, as in the prior art, to incorporate the non-linear crystal in the laser cavity to obtain a certain proportion of frequency doubled light. It is thus possible to take a conventional laser source and arrange a heat-adjusted unit comprising the non-linear crystal on the optical axis of the laser beam exiting the laser source.

### BRIEF DESCRIPTION OF THE DRAWINGS

Other particular features of the invention will be described below with reference to the annexed drawings, given by way of non-limiting example, and in which:

FIG. 1, already described, shows the dependence of luminous absorption according to wavelength for various metals at ambient temperature.

FIG. 2, already described, shows the dependence of the luminous absorption of copper according to the temperature of the metal.

FIG. 3 shows schematically a power profile of a laser pulse according to the invention with the components at two wavelengths present after passing through a non-linear crystal.

FIG. 4 shows a preferred implementation of the laser machining method according to the invention.

FIG. 5 is a schematic view of a first embodiment of a laser machining equipment according to the invention.

FIG. 6 is a schematic view of a second embodiment of a laser machining equipment according to the invention.

### DETAILED DESCRIPTION OF THE INVENTION

The laser machining method of the invention includes the following steps:
A) Generating, by means of a laser source, a laser beam having a wavelength of between 700 and 1200 nanometres formed of a series of laser pulses.
B) Doubling the frequency of one part of the laser beam by means of a non-linear crystal.
C) Varying the power during each emitted laser pulse so that, throughout the period of this laser pulse, the power profile has a maximum peak power or part of the pulse with a maximum power in an initial sub-period T1, and in a second intermediate sub-period T2 of longer duration than the initial sub-period and occurring thereafter, a lower power than said maximum power throughout the entire intermediate sub-period.

The value of the maximum power variation is at least two times higher than the mean power throughout the period of the laser pulse and the time of increase to said maximum power from the start of each laser pulse is less than 3/10 milliseconds (0.3 ms).

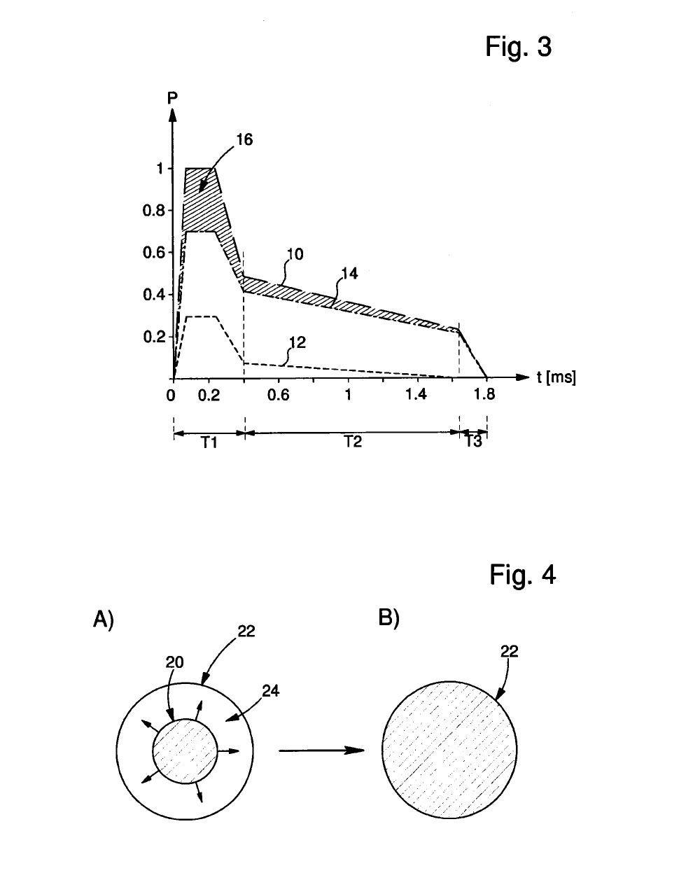

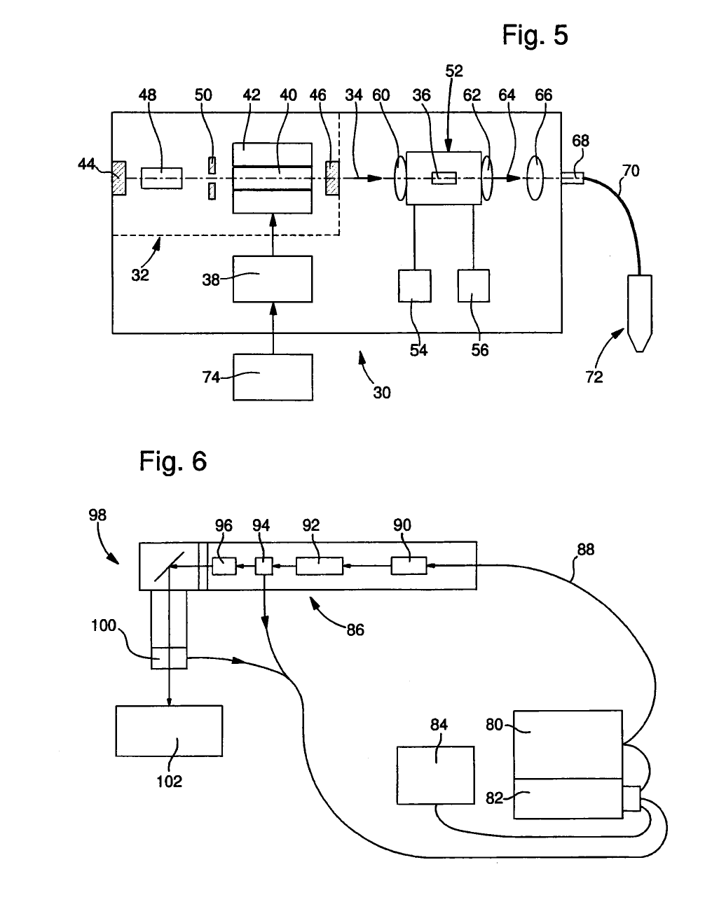

FIG. 3 shows a normalised power profile variant (relative scale with maximum at 1) of the laser pulses according to the present invention. Curve 10 represents the total laser power emitted during a pulse. After passing through the non-linear crystal, one part of the initial frequency light from the laser source is converted into frequency doubled light. The resulting power curve for this frequency doubled light or radiation is schematically and approximately represented by curve 12. The remaining initial light power is given by curve 14. The hatched surface 16 therefore represents the part of generated laser light whose frequency has been doubled. It will be noted that the luminous power of the frequency doubled light is proportional to the square (mathematical power of 2) of the initial luminous power. Indeed, for a normalised initial power of ‘1’, a frequency doubled luminous power for example of 0.3 (30%) is obtained, whereas when the initial power is decreased by two to 0.5 (50%), the frequency doubled luminous power is reduced by four to around 0.075 (7.5%). It will be noted that a conversion rate of 30% corresponds in practice to the maximum for a standard industrial flash lamp and/or diode pumped laser with a peak power of less than 10 kW and pumping pulses of several milliseconds, when this type of laser is associated with a frequency doubling unit external to the resonator (as in FIGS. 5 and 6 which will be described below). It will be noted however that it is possible to obtain higher conversion rates with fibre optic lasers supplying a very high quality laser beam (M² close to 1.0).

In the initial phase, the laser source is controlled to rapidly reach the maximum power provided, to obtain an optimal frequency doubled luminous power within a short time. Generally, the duration of increase to maximum power is less than 3/10 ms (0.3 ms). In a preferred variant, the power is arranged to be increased as quickly as possible at the start of the laser pulse, to obtain a maximum of frequency doubled light as soon as possible. The duration of increase to maximum power is then less than 0.1 ms. In a particular variant, this duration of increase is less than 50 μs (0.05 ms).

The laser pulse ends in an end sub-period T3 of power decrease towards zero preferably with control of this decrease to influence the cooling of a weld performed and to optimise metallurgy.

To properly understand the physical mechanism obtained by laser pulses with a power profile according to the invention, reference may be made to the variant of FIG. 3 in an application to laser welding copper elements with infra-red light (1064 or 1070 nm). In the initial sub-period T1 where power is maximum, it may be assumed for example that 20% of infra-red light is converted into green light (532 or 535). Therefore 80% of incident infra-red light remains on the surface of the metal. However, 20-40% of the green light energy is absorbed while only 5-10% of the infra-red energy is absorbed. Therefore the coupling of green light in the metal is around 4-8% of the total energy, which is also the proportion of green light coupled to the metal. Thus, in the initial sub-period, the green light contributes as much as the infra-red light to melting the metal, while the conversion performed by the non-linear crystal is only 20%. It will be noted that at the start of the initial sub-period, while the temperature of the metal has not yet been significantly increased by the supply of energy, the quantity of energy at the initial frequency which is absorbed by the metal is generally lower than that of the doubled frequency which then plays a major part. Once the temperature of the metal increases sufficiently, the ratio between the two coupled energies varies and the quantity of absorbed infra-red energy becomes preponderant. As soon as the quantity of absorbed infra-red energy increases sharply, the luminous power is reduced; which defines intermediate sub-period T2 of each laser pulse according to the invention.

Within the scope of the invention, the laser pulses are obtained either by a flash lamp pumped laser, or by a diode pumped laser operating in a first variant in modulated CW mode and in a second variant in QCW mode. If the laser is, for example, a solid state Nd:YAG or similar type of laser, the pumping means is formed, in a first variant, by a flash lamp and, in another variant by diodes. In a preferred embodiment, a diode pumped fibre laser is used. The latter provides a better quality beam which can be focussed better; which increases the conversion rate of the non-linear crystal. In the initial sub-period T1, the maximum power may vary between 50 W (Watts) and 20 kW. This depends in particular on the diameter provided for the laser spot on the surface of the machined material.

The period of the laser pulses is not limited, but is generally between 0.1 ms and 100 ms (milliseconds). In a preferred variant, in particular for a welding application, the duration of initial sub-period T1 is less than 2 ms. A typical duration for intermediate sub-period T2 is within the range of 1 ms to 5 ms with the condition of the invention that T2 is greater than T1.

In a preferred implementation of the method according to the invention, the value of the maximum power of the laser pulse temporal profile is at least two times higher than the mean power throughout the period of said laser pulse. In a particular variant, the maximum power is higher than 200 W. In the latter case, the laser source operates in QCW mode or a flash lamp or diode pulsed mode. In the modulated CW mode, the maximum power in phase T1 matches the maximum CW power and the CW power is then reduced in the next phase T2.

The applications envisaged for the method of the invention are multiple, in particular the continuous or spot welding of metals, cutting and etching metals and hard materials such as ceramics, CBN or PKD.

In a particular mode, a means of focussing the laser beam is provided, which may or may not be totally chromatically compensated, to obtain a light spot at the focal point for the frequency doubled light having a smaller diameter than that of the light spot for the light at the initial wavelength. Thus, this particular embodiment of the invention takes advantage of the fact that the divergence of the frequency doubled light is different from that of the single frequency light, by a factor of around two. As shown in FIG. 4A, the light spot formed by the incident beam on the machined material has, in central area 20, a mixture of two types of radiation, whereas the annular area 24 only receives the single frequency light, the light spot 22 of which has a larger diameter than that of the frequency doubled light spot defining central area 20. Owing to this feature, the absorption of energy in an initial phase of a laser pulse essentially occurs in central area 20 where the machining is started efficiently since the frequency doubled light is concentrated in this central area and the intensity thereof is thus much higher than it would be if the frequency doubled light covered substantially all of light spot 22. This particular embodiment is especially advantageous in an application to welding metallic elements.

The following description of the method of the invention will consider the welding of a highly reflective metal. In particular, the welded metal is copper, gold, silver, aluminium or an alloy containing one of these metals.

As mentioned above, the particular embodiment of the method of the invention described with reference to FIG. 4 is efficiently applied to welding. The frequency doubled light is concentrated in central area 20. Since this light is relatively well absorbed by the metal, a certain amount of energy is introduced into the metal in the central area and increases the local temperature to the melting temperature. Thus the intensity of the frequency doubled light combined with the light at the initial frequency in the power peak or the part of the pulse with a maximum power of each laser pulse is higher than the melting threshold for this combination of light and for the material being welded. It will be noted that the melting of the metal depends first of all on the luminous intensity, i.e. the power density, and also on the duration of said luminous intensity. Thus, it is clear that the concentration of frequency doubled light (green light) in the case of a solid state laser (for example Nd:YAG) or a fibre laser (for example doped Yb) in a central area allows the melting point threshold to be reached with a lower power laser, not just because the frequency of the infra-red light is doubled (for two given lasers here in the example) but also because this green light is concentrated in a light spot which is around four times smaller than the light spot obtained for the infra-red light. A luminous intensity multiplied by around four is thus obtained.

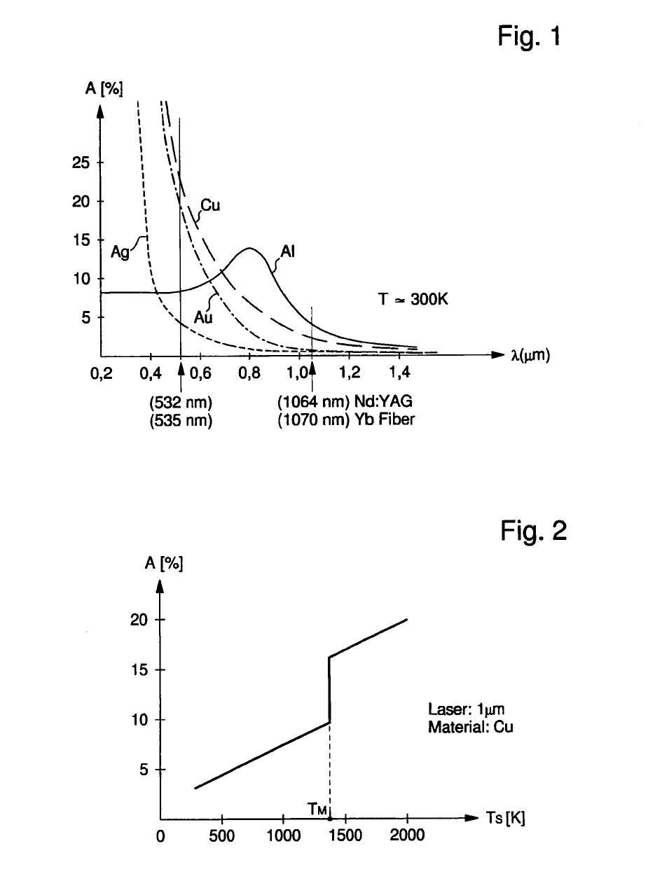

Based on the absorption features of light by highly reflective metals given in FIG. 1, it is clear that the energy is initially absorbed in central area 20 where the metal starts to melt after a certain time period (schematically represented by the hatching in FIG. 4A). The energy is rapidly diffused in the surrounding area (for copper, the diffusion of heat is around 0.3 mm per millisecond, which is represented by the arrows in FIG. 4A). The temperature therefore increases in the annular area 24 and finally the single frequency light (infra-red) is also significantly absorbed over the entire light spot 22, which leads to a fusion of metal in the area of the surface thereof defined by said light spot 22, as shown in FIG. 4B. The weld is therefore performed from the central area of the incident laser beam on the surface of the metal to be welded. It will be noted that, depending on the duration of the laser pulse and the luminous intensity of the infra-red light in end sub-period T2, the final area in which the metal melts is wider or narrower and larger than the light sport 22, since the metal is a good heat conductor.

It will also be noted that the power of the laser can be controlled and particularly varied in the intermediate sub-period to optimise welding. In particular, the luminous intensity is controlled to keep the temperature of the melted material in the welding area substantially constant, at least in a first part of said intermediate sub-period. The power profile of the intermediate sub-period can be controlled in real time via a sensor or determined empirically, particular by preliminary tests. Various methods are available to those skilled in the art.

In a particular variant, the frequency doubled light intensity in the initial sub-period T1 is greater than 0.1 MW/cm² at the focal point located substantially on the future weld. Preferably, the maximum power of the light pulse for a given laser is arranged to be as high as possible, while avoiding piercing in the case of a welding application. In this preferred variant, the intensity of frequency doubled light in the initial sub-period T1 has a power peak higher than 1.0 MW/cm² at the focal point.

In a variant optimising the power of the laser device for a given weld, the light intensity at the initial wavelength (infra-red light) in the power peak or the part of the pulse at maximum power is lower than the melting point for this light at ambient temperature for the welded metal. In particular, the intensity of light at the initial wavelength is less than 10 MW/cm² at the focal point.

Two embodiments of a laser equipment according to the invention will be described below in a non-limiting manner.

In FIG. 5, the laser machining equipment 30 includes:
a coherent light source 32 generating a laser beam 34 with an initial wavelength of between 700 and 1200 nm;
a non-linear crystal 36 for partially doubling the laser beam frequency;
a means 38 of controlling said light source arranged to generate laser pulses.

This equipment is characterized in that the control means 38 is arranged to form laser pulses having a power profile throughout the period of each laser pulse with, in an initial sub-period, a maximum power peak or a part of the pulse with a maximum power, and in an intermediate sub-period of greater duration than the initial sub-period and immediately thereafter, a lower power than said maximum power throughout the entire intermediate sub-period (see FIG. 3 described above). The maximum power is arranged to be at least two times higher than the mean power throughout the period of the laser pulse and the time of increase to said maximum power from the start of each laser pulse is less than 300 μs (0.3 ms).

The coherent light source (laser source) is formed of an active medium 40 optically pumped by a pumping means 42. In a first variant, this pumping means is formed by one or several flash lamps. In a second variant, the pumping means is formed by a plurality of diodes. The laser source includes a resonant cavity formed by a totally reflective mirror 44 and an output mirror 46 which is semi-reflective at the selected transmitted wavelength (particularly at 1064 nm for an Nd:YAG). A polariser 48 and a diaphragm 50 are also arranged in the resonant cavity.

Non-linear crystal 36 is selected to efficiently double the frequency of laser beam 34. This crystal is arranged in a dustproof case 52. The case is preferably heat-regulated, particularly by using a Peltier module 54 and an vacuum is generated in the case by means of a pump 56. At the entry to the case an optical focusing system 60 is arranged to increase luminous intensity on the frequency doubling crystal 36 since the efficiency thereof depends on the intensity of incident light. An optical system 62 transparent at 532 nm and 1064 nm, is also provided for collimating laser beam 64 including a mixture of two types of radiation at the initial frequency (single frequency) and the doubled frequency. This beam 64 is then introduced into a fibre optic 70 by means of an optical focusing system 66 and a connector 68. Fibre optic 70 leads light beam 64 to a machining head 72.

The control means 38 acts on pumping means 42. Control means 38 is associated with the electric power supply for the pumping means and can form a single functional unit or the same module. This control means is connected to a control unit 74 arranged to allow a user to enter certain selected values for adjustable parameters so as to define the power profile of the laser pulses generated by laser source 32 so as to implement the laser machining method according to the present invention described above. Control unit 74 can be assembled to the laser equipment or form an external unit, such as a computer. In particular, control means 38 is arranged to form laser pulses with an initial sub-period in which the maximum power of the pulse occurs, an intermediate sub-period of greater duration and an end sub-period where the emitted power decreases to zero. In a preferred variant, the duration of the initial sub-period is less than two milliseconds (2 ms). Next, this control means is arranged to obtain a relatively short time of increase to maximum temperature which is in any event less than 300 μs.

In a first embodiment, the laser source is arranged to operate in QCW mode (specific diode pumping), so as to obtain a relatively high peak power in the initial sub-period, well above the mean power of the laser, and relatively long pulses. In a second embodiment, the laser source operates in modulated CW mode with diode pumping. In a third embodiment, the laser source is flash lamp pumped, i.e. it operates in pulsed mode.

According to a particular embodiment, particularly for a welding application, the laser machining equipment includes, downstream of non-linear crystal 36, optical focusing elements of the laser beam which are not, or not totally chromatically compensated, so as to obtain, at the focal point, a light spot for the frequency doubled light which has a smaller diameter than that of the light spot for the light at the initial wavelength (see FIG. 4A described above).

Equipment 30 forms a welding equipment for highly reflective metals, for example copper or gold. In this application, this equipment 30 is arranged to obtain a frequency doubled luminous intensity of more than 0.1 MW/cm² at the focal point. Preferably, the intensity of the frequency doubled light in the initial sub-period T1 has a power peak of more than 1.0 MW/cm² at the focal point. In order to limit the power of the laser source, an advantageous variant provides for the luminous intensity at the initial wavelength to be less than 10 MW/cm².

It will be noted that in another embodiment not shown in the Figures, the non-linear crystal may be incorporated into the resonant cavity of the laser source. However, this arrangement is not preferred, since it requires construction of the laser source specific to the present invention, whereas assembling the non-linear crystal outside the resonant cavity, after the laser source, allows a standard laser source, available on the market, to be used. This is an important economical advantage.

FIG. 6 shows a schematic view of a second embodiment of a laser equipment according to the invention. First of all, the coherent light is generated by a fibre laser 80 optically pumped by diodes. It preferably operates in QCW mode. This laser 80 is associated with a control means 82 arranged to form laser pulses in accordance with the present invention (see FIG. 3 described above). This control means defines a means of forming laser pulses with a specific power profile. It is connected to a control unit 84 with a user interface. The laser pulses at the initial frequency are sent via an optical cable 88 to a unit 86 for processing the laser beam formed of these pulses, which is directly assembled to machining head 98. This processing unit 86 includes a collimator 90 for substantially collimating the laser beam or focusing it on the non-linear crystal incorporated in unit 92 for doubling the frequency of part of the initial laser light. This unit 92 may include a specific optical system for optimising the efficiency of the frequency doubled light conversion (green light in the case of a doped fibre laser Yb, which emits a laser light with a wavelength of 1070 nm).

In a variant, downstream of the frequency doubler, there is a sensor 94 for measuring respective powers for the light at the initial frequency and/or for the frequency doubled light. Next, optionally, there is a zoom device 96 for enlarging the transverse section of the beam before it enters the machining head 98. This machining head is fitted with one or more sensors 100, for example for measuring the surface temperature of the machined material 102 in the area of impact of the laser beam or for measuring the light reflected by said surface. Sensors 94 and 100 are connected to control means 82 to allow the power profile of the laser pulses to be varied in real time according to the measurements made.

1-28. (canceled)

29. A laser machining method comprising:
A) generating, by a laser source, a laser beam having a wavelength of between 700 and 1200 nanometers formed of a series of laser pulses;
B) doubling the frequency of one part of said laser beam by a non-linear crystal;
C) varying luminous power emitted during each laser pulse so that the power profile at the initial wavelength throughout a period of the laser pulse has, in an initial sub-period, a power peak with a maximum power or part of the pulse with a maximum power and, in an intermediate sub-period of longer duration than the initial sub-period and occurring thereafter, a lower power than the maximum power throughout the entire intermediate sub-period, the maximum power having a value at least two times higher than the mean power throughout the period of the laser pulse and an increase time to the maximum power from the start of each laser pulse being less than 0.3 millisecond (300 μs).

30. The laser machining method according to claim 29, wherein the duration of the initial sub-period is less than two milliseconds (2 ms).

31. The laser machining method according to claim 29, wherein the variation in power of each laser pulse is carried out so that the increase time to the maximum power is less than 0.05 millisecond (50 μs).

32. The laser machining method according to claim 29, wherein the maximum power is higher than 200 W, the laser source operating in QCW mode.

33. The laser machining method according to claim 29, wherein a means of focusing the laser beam is provided, which are not or not totally chromatically compensated, to obtain a light spot at a focal point for the frequency doubled light having a smaller diameter than that of the light spot for the light at the initial wavelength.

34. The laser machining method according to claim 29, wherein the method welds a highly reflective metal.

35. The laser machining method according to claim 34, wherein intensity of the frequency doubled light combined with light at an initial frequency in the power peak or part of the pulse with a maximum power of each laser pulse is higher than a melting threshold, in the initial sub-period, for a combination of light and for the metal being welded.

36. The laser machining method according to claim 35, wherein the frequency doubled light intensity is higher than 0.1 MW/cm² at the focal point.

37. The laser machining method according to claim 35, wherein the intensity of light at the initial wavelength in the power peak or part of the pulse with maximum power is lower, in the initial sub-period, than the melting threshold for the light and for the welded metal.

38. The laser machining method according to claim 37, wherein the light intensity at the initial wavelength is lower than 0.1 MW/cm² at the focal point.

39. The laser machining method according to claim 34, wherein the welded metal is copper, gold, silver, aluminium, or an alloy containing one of these metals.

40. The laser machining method according to claim 34, wherein the laser pulses have an end sub-period in which the power decreases to zero so as to optimize cooling of the weld formed.

41. A laser machining equipment including:
a coherent light source generating a laser beam with an initial wavelength of between 700 nm and 1200 nm;
a non-linear crystal for partially doubling the laser beam frequency;
a means of controlling the light source arranged to generate laser pulses;
wherein the control means is configured to form the laser pulses with a power profile throughout the period of each laser pulse which has, in an initial sub-period, a power peak with a maximum power or a part of the pulse with a maximum power and, in an intermediate sub-period of longer duration than the initial sub-period and occurring immediately thereafter, a lower power than the maximum power throughout the intermediate sub-period, wherein the control means is further configured so that the value of the maximum power is at least two times higher than mean power throughout the period of the laser pulse, and wherein an increase time to the maximum power from the start of each pulse is less than 0.3 millisecond (300 μs).

42. The laser machining equipment according to claim 41, wherein the coherent light source is diode pumped and operates in QCW mode.

43. The laser machining equipment according to claim 41, wherein the coherent light source is formed by a fiber laser.

44. The laser machining equipment according to claim 41, wherein the duration of the initial sub-period is less than two milliseconds (2 ms).

45. The laser machining equipment according to claim 41, wherein the duration of the increase time is less than 0.05 millisecond (50 μs).

46. The laser machining equipment according to claim 41, further comprising optical elements for focusing the laser beam, which are not or not totally chromatically compensated, to obtain a light spot at a focal point for the frequency doubled light having a smaller diameter than that of the light spot for the light at the initial wavelength.

47. The laser machining equipment according to claim 41, defining a welding equipment for highly reflective metals.

48. The laser machining equipment according to claim 47, wherein the frequency doubled light intensity is higher than 0.1 MW/cm² at the focal point.

49. The laser machining equipment according to claim 47, wherein the light intensity at the initial wavelength is lower than 10 MW/cm² at the focal point.

50. The laser machining equipment according to claim 47, wherein the control means is further configured to form the laser pulses with a power profile having an end sub-period during which the power decreases to zero to optimize cooling of the weld formed.

51. The laser machining equipment according to claim 41, further comprising a sensor for measuring the frequency doubled light power, the sensor being connected to the control means to vary the laser pulses in real time according to a measurement of the frequency doubled light power.

52. The laser machining equipment according to claim 41, further comprising a sensor for measuring temperature of a surface of the machined material in the laser beam impact area or for measuring light reflected by the surface, the sensor being connected to the control means to vary a profile of the laser pulses in real time according to a measurement of the temperature or of the reflected light.

53. The laser machining equipment according claim 41, wherein the control means is further configured so that the increase time to the maximum power is substantially less than 0.1 millisecond (100 μs).

54. The laser machining equipment according to claim 47, wherein the frequency doubled light intensity is higher than 1.0 MW/cm² at the focal point.

55. The laser machining method according to claim 29, wherein the variation in power of each laser pulse is carried out so that the increase time to the maximum power is less than 0.1 millisecond (100 μs).

56. The laser machining method according to claim 55, wherein the frequency doubled light intensity is higher than 1.0 MW/cm² at the focal point.
